(19) United States
(12) Patent Application Publication
(10) Pub. No.: US 2013/0005162 A1
(43) Pub. Date: Jan. 3, 2013

(54) MULTIPLE SOCKET CONCEPT

(76) Inventors: Debendra MALLIK, Chandler, AZ (US); Ajit V. SATHE, Chandler, AZ (US)

(21) Appl. No.: 13/175,515

(22) Filed: Jul. 1, 2011

(51) Int. Cl. H01R 12/50; H01R 43/20

(52) U.S. Cl. 439/78; 29/876

(57) ABSTRACT

Electronic assemblies and their manufacture are described. One assembly includes a land grid array package including a plurality of land contacts. The assembly also includes a first socket adapted to engage a first group of the plurality of land contacts, and a second socket adapted to engage a second group of the plurality of land contacts. The first socket and the second socket are each coupled to a board. The first socket and the second socket are separate structures on the board. Other embodiments are described and claimed.

### RELATED ART

Integrated circuits may be formed on semiconductor wafers made of materials such as silicon. The semiconductor wafers are processed to form various electronic devices. The wafers are diced into semiconductor chips (a chip is also known as a die), which may then be attached to a package substrate using a variety of known methods. One type of package substrate is known as a land grid array (LGA) package, which typically includes flat plated gold pads as input/output contacts on the package. The package substrate may then be attached to a printed circuit board (PCB) such as a motherboard through a socket. One advantage of a socket connection is that it is generally possible to remove the package substrate from the socket if desired. The socket typically includes a frame. The socket includes upper contacts that are positioned to electrically couple to the land contacts to the LGA package substrate, and lower contacts that are coupled to the board using, for example, solder bumps.

### BRIEF DESCRIPTION OF THE DRAWINGS

Embodiments are described by way of example, with reference to the accompanying drawings, which are not drawn to scale, wherein:

FIG. 1 illustrates a top view of a dual socket arrangement, in accordance with certain embodiments;

FIG. 2 illustrates a side cross-sectional view of a dual socket arrangement, in accordance with certain embodiments;

FIG. 3 illustrates a top view of a dual socket arrangement, including an IC chip on an LGA substrate that is positioned in the sockets, in accordance with certain embodiments;

FIG. 4 illustrates a side cross-sectional view of a dual socket arrangement, including an IC chip on an LGA substrate that is positioned in the sockets, in accordance with certain embodiments;

FIG. 5 illustrates a top view of a multiple socket arrangement including four sockets, in accordance with certain embodiments;

FIG. 6 illustrates a side cross-sectional view of a multiple socket arrangement including four sockets, in accordance with certain embodiments;

FIG. 7 illustrates a top view of a four socket arrangement, further including an IC chip on an LGA substrate that is positioned in the sockets, in accordance with certain embodiments;

FIG. 8 illustrates a side cross-sectional view of a four socket arrangement, further including an IC chip on an LGA substrate that is positioned in the sockets, in accordance with certain embodiments;

FIG. 9 illustrates a flow chart of process operations, in accordance with certain embodiments;

FIG. 10 illustrates an electronic system arrangement in which embodiments may find application.

### DETAILED DESCRIPTION

As electronic devices continue to increase in density, reduction of the height of the electronic assembly becomes essential. As more contacts are needed on a package, a socket likewise needs more contacts. The ability to increase the number of contacts in existing LGA socket structures is very limited. As a result, an LGA socket with a larger area for contacts has been contemplated. However, the combination of larger socket area and the need for reduced socket height leads to problems. An increased socket area coupled with reduced height leads to problems with warpage of the socket structure. Socket structures are typically formed from polymer materials. If the LGA socket is substantially warped, then one or more of the following problems may occur, including: (i) non-uniform electrical contact between the package substrate contacts and the contacts in the socket; (ii) stress concentration on parts of the package, which can lead to a shorter lifetime; (iii) difficulties in fitting the package into the socket and applying force to hold the package in the socket without damaging the package.

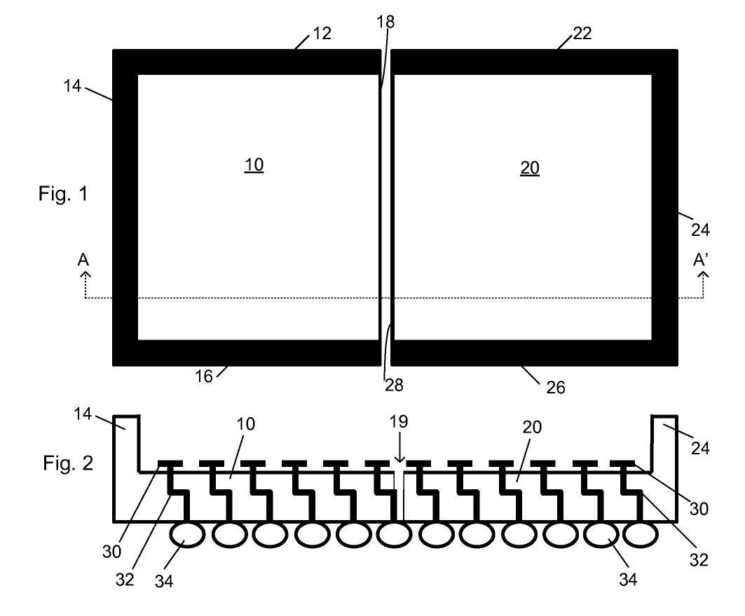

Certain embodiments relate to assemblies and methods that permit the use of additional contacts while keeping the socket height minimal. FIGS. 1-2 illustrate a dual socket embodiment including two LGA sockets 10, 20. FIG. 1 is a top view and FIG. 2 is a side cross-sectional view along the dotted line A-A′. As seen in FIG. 1, the socket 10 includes sidewalls 12, 14, and 16 extending around three sides of the socket. The fourth side 18 of the socket 10 does not have a sidewall, so that an LGA package can fit within the socket 10 and extend beyond side 18. The socket 20 similarly includes three sidewalls 22, 24, and 26. The fourth side 28 has no sidewall, and a package may be positioned to fit in both sockets 10 and 20, extending over the sides 18 and 28 and within the walls 12, 14, 16, 22, 24, and 26. As illustrated in the embodiment of FIGS. 1-2, a gap 19 exists between the side 18 of socket 10 and the side 24 of socket 20. The gap 19 may be very narrow so as to permit contacts on the package substrate located close to the gap 19 to be able to be properly positioned onto socket contacts. The sockets 10 and 20 may be formed as separate structures whose frames are not directly attached to each other. It may be possible in certain embodiments that the adjacent sockets could be touching, however, the sockets themselves are independent structures which may be coupled to a board separately.

As illustrated in FIG. 2, a plurality of socket contacts 30 are positioned in each of the sockets 10 and 20. These contacts 30 are electrically coupled through pathways 32 to contacts 34 on the bottom of the sockets 10 and 20. The contacts 34 may be coupled to a board such as, for example, a motherboard, using, for example, solder bumps 34.

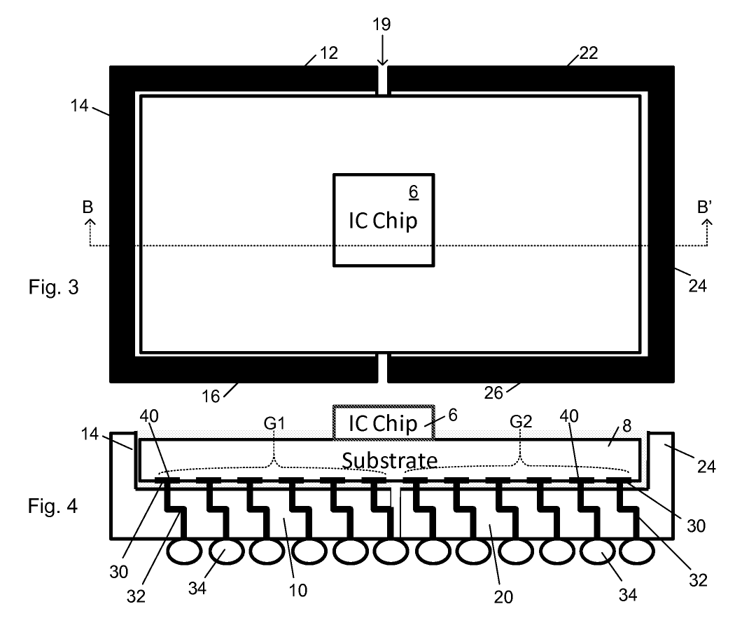

FIGS. 3-4 illustrate a top view and a side cross-sectional view (along the dotted line B-B′) of a dual socket arrangement such as illustrated in FIGS. 1-2, including an LGA package substrate having an integrated circuit (IC) chip 6 positioned thereon. The package fits within the walls 12, 14, 16 of socket 10 and within the walls 22, 24, 26 of socket 20. The package also extends over the gap 19 between the sockets 10 and 20. As illustrated in FIG. 4, the LGA substrate includes land contacts 40 that are positioned in electrical contact with the socket contacts 30 in each of the sockets 10 and 20. A first group G1 of the land contacts 40 will be positioned within the socket 10, and a second group G2 of the land contacts 40 will be positioned within the socket 20, as indicated by the dotted line brackets in FIG. 4. Any suitable LGA contact structure may be used. In addition, any suitable apparatus and method for applying a force to ensure proper contact between the land contacts on the package and the socket contacts may be utilized, if desired. Certain embodiments may utilize a single apparatus to apply a force to hold the LGA package to both sockets at the same time.

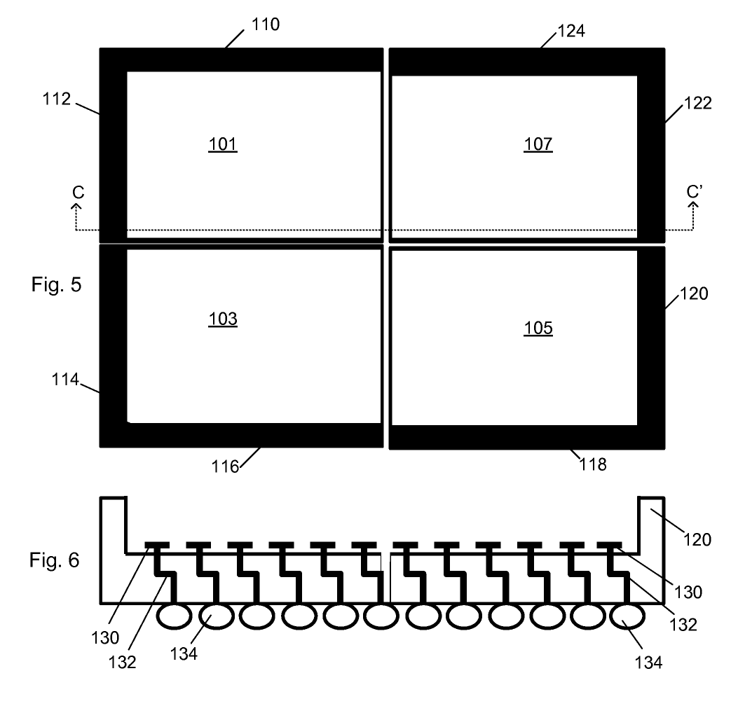

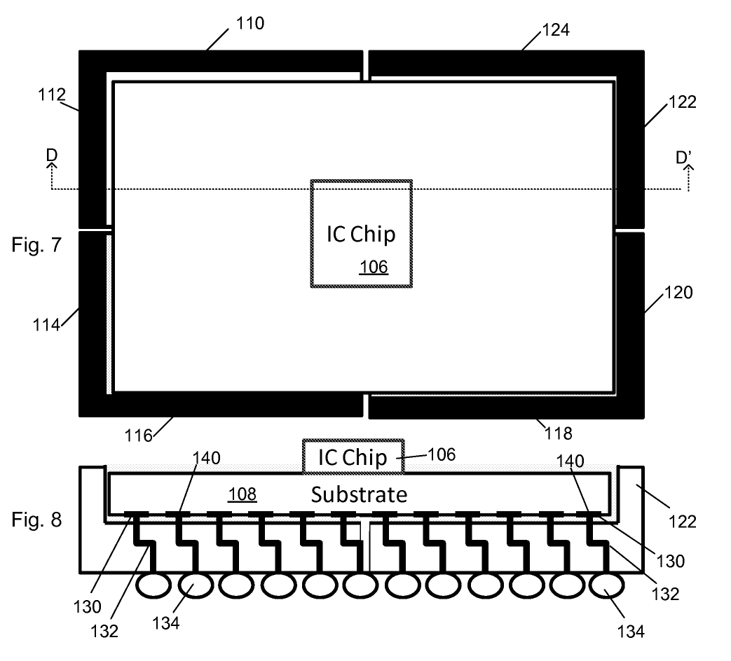

Embodiments also may utilize more than two socket structures into which a single package is positioned. FIGS. 5 and 6 illustrate a top view and a side cross-section view (along the dotted line C-C′) of an embodiment in which four LGA sockets 101, 103, 105, and 107 are utilized to contain an LGA package. The sockets each include two sidewalls forming a corner region, with socket 101 including sidewalls 110 and 112, socket 103 including sidewalls 114 and 116, socket 105 including sidewalls 118 and 120, and socket 107 including sidewalls 122 and 124. FIGS. 7 and 8 illustrate a top view and a side cross-sectional view (along the dotted line D-D′) of a socket arrangement such as in FIGS. 5 and 6, including a package substrate 108 and IC chip 106 positioned on the four sockets 101, 103, 105, and 107. In this embodiment, with four sockets being used, the sockets may be formed to be very thin, because the individual socket area may be relatively small.

In addition, when two sockets were used to contain a package, as described above, each socket included three sidewalls, which may be used to assist in positioning the package. When four sockets are used, each socket includes two sidewalls, as illustrated in FIGS. 5 and 7. It should be appreciated that the sidewalls, while illustrated as extending along the entire length of a side of the socket, may also be formed to extend along only a part of a side of the socket, or could have a number of spaced apart openings. In other embodiments, the wall may be formed from a number of spaced apart structures such as pins. A purpose for the wall is to assist in the positioning of the substrate in the socket, so the wall may act as an alignment mechanism. As a result, a continuous wall may not be necessary to ensure proper positioning of the substrate in the socket.

In addition, various embodiments may include any number of sockets may be used, with certain embodiments including either two or four. Depending on the number of sockets used, it is possible that no walls would be need for sockets that are positioned in an interior region. In addition, depending on the layout of the package contacts, the sockets could vary in size and shape from one another.

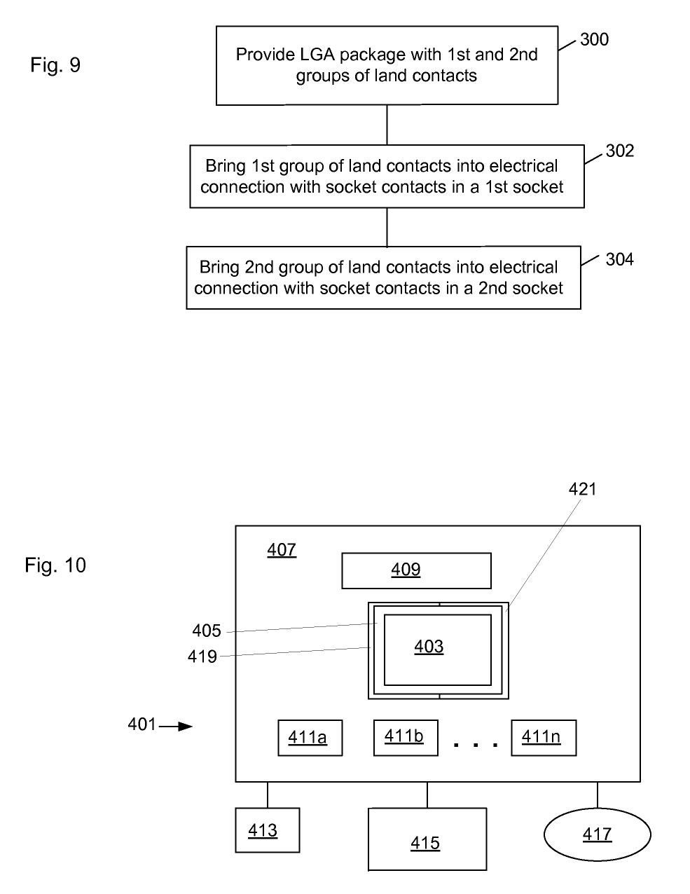

FIG. 9 illustrates a flowchart of operations, in accordance with certain embodiments. Box 300 is providing an LGA package having first and second groups of separate land contacts. Box 302 is bringing the first group of land contacts into electrical contact with socket contacts in the first socket. Box 304 is bringing the second group of land contacts into electrical contact with socket contacts in the second socket. In certain embodiments the first group and the second group are brought into contact with the socket contacts at the same time or approximately the same time.

Certain embodiments may provide one or more of the following advantages when compared with conventional single socket mounting of packages. First, in accordance with certain embodiments, a more thin and less warped socket may be manufactured because the socket may have a smaller area. Second, by using multiple thin sockets that are less likely to have warpage problems, more area may be available for obtaining a higher number of contacts. Third, it may be simpler to produce a greater number of smaller sockets, instead of forming a single large socket.

Assemblies including components formed as described in embodiments above may find application in a variety of electronic components. FIG. 10 schematically illustrates one example of an electronic system environment in which aspects of described embodiments may be embodied. Other embodiments need not include all of the features specified in FIG. 10, and may include alternative features not specified in FIG. 10.

The system 401 of FIG. 10 may include at least one central processing unit (CPU) 403. The CPU 403, also referred to as a microprocessor, may be a die which is attached to an integrated circuit package substrate 405, which is then coupled to a printed circuit board 407 (for example, a motherboard) through sockets 419 and 421. The sockets 419 and 421 to which the package substrate 405 containing the CPU 403 is coupled are an example of an assembly that may be formed in accordance with embodiments such as described above, including multiple socket structures to contain a package. A variety of other system components, including, but not limited to memory and other components discussed below, may also include structures formed in accordance with embodiments such as described above.

The system 401 may further include memory 409 and one or more controllers 411a, 411b . . . 411n, which are also disposed on the motherboard 407. The motherboard 407 may be a single layer or multi-layered board which has a plurality of conductive lines that provide communication between the circuits in the package 405 and other components mounted to the board 407. Alternatively, one or more of the CPU 403, memory 409 and controllers 411a, 411b . . . 411n may be disposed on other cards such as daughter cards or expansion cards. The CPU 403, memory 409 and controllers 411a, 411b . . . 411n may each be seated in sockets or may be connected directly to a printed circuit board or all integrated in the same package. A display 415 may also be included.

Any suitable operating system and various applications execute on the CPU 403 and reside in the memory 409. The content residing in memory 409 may be cached in accordance with known caching techniques. Programs and data in memory 409 may be swapped into storage 413 as part of memory management operations. The system 401 may comprise any suitable computing device, including, but not limited to, a mainframe, server, personal computer, workstation, laptop, handheld computer, netbook, tablet, book reader, handheld gaming device, handheld entertainment device (for example, MP3 (moving picture experts group layer-3 audio) player), PDA (personal digital assistant) telephony device (wireless or wired), network appliance, virtualization device, storage controller, network controller, router, etc.

The controllers 411a, 411b . . . 411n may include one or more of a system controller, peripheral controller, memory controller, hub controller, I/O (input/output) bus controller, video controller, network controller, storage controller, communications controller, etc. For example, a storage controller can control the reading of data from and the writing of data to the storage 413 in accordance with a storage protocol layer. The storage protocol of the layer may be any of a number of known storage protocols. Data being written to or read from the storage 413 may be cached in accordance with known caching techniques. A network controller can include one or more protocol layers to send and receive network packets to and from remote devices over a network 417. The network 417 may comprise a Local Area Network (LAN), the Internet, a Wide Area Network (WAN), Storage Area Network (SAN), etc. Embodiments may be configured to transmit and receive data over a wireless network or connection. In certain embodiments, the network controller and various protocol layers may employ the Ethernet protocol over unshielded twisted pair cable, token ring protocol, Fibre Channel protocol, etc., or any other suitable network communication protocol.

Terms such as “first”, “second”, and the like as used herein to not necessarily denote any particular order, quantity, or importance, but are used to distinguish one element from another. Terms such as “top”, bottom”, “upper”, and “lower” and the like as used herein refer to the orientation of features as illustrated in the attached figures.

While certain exemplary embodiments have been described above and shown in the accompanying drawings, it is to be understood that such embodiments are merely illustrative and not restrictive, and that embodiments are not restricted to the specific constructions and arrangements shown and described since modifications may occur to those having ordinary skill in the art.

What is claimed:

1. An assembly comprising:
a land grid array package comprising a plurality of land contacts;
a first socket adapted to engage a first group of the plurality of land contacts;
a second socket adapted to engage a second group of the plurality of land contacts;
wherein the first socket and the second socket are each coupled to a board;
wherein the first socket and the second socket are separate structures on the board.

2. The assembly of claim 1, wherein the first socket comprises a body comprising a polymer and a plurality of electrically conductive socket contacts that are positioned to engage the first group of the plurality of land contacts, and wherein the second socket comprises a body comprising a polymer and a plurality of electrically conductive socket contacts that are positioned to engage the second group of the plurality of land contacts.

3. The assembly of claim 1, wherein the first group and the second group of the plurality of land contacts includes all of the land contacts on the land grid array package.

4. The assembly of claim 1, wherein the first group and the second group of the plurality of land contacts include less than all of the land contacts on the land grid array package.

5. The assembly of claim 4, further comprising a third group of the plurality of land contacts and a fourth group of the land contacts, wherein the first group, the second group, the third group, and the fourth group includes all of the land contacts on the land grid array package.

6. The assembly of claim 5, further comprising:
a third socket adapted to engage the third group of the plurality of land contacts;
a fourth socket adapted to engage the fourth group of the plurality of land contacts;
wherein the third socket and the fourth socket are each coupled to the board; and
wherein the first socket, the second socket, the third socket, and the fourth socket are separate structures on the board.

7. The assembly of claim 1, wherein the first socket and the second socket each define an area that is smaller than that of the land grid array package.

8. An assembly comprising:
a land grid array package comprising a plurality of land contacts on a surface thereof;
a plurality of sockets adapted to engage the land contacts, the sockets sized and positioned so that each socket engages only a group of the plurality of land contacts;
wherein the plurality of land contacts includes a plurality of separate groups of land contacts; and
wherein the plurality of sockets includes one socket for each separate group of land contacts.

9. The assembly of claim 8, wherein the sockets comprise discrete structure.

10. The assembly of claim 9, wherein the sockets each comprise a polymer and a plurality of metal socket contacts.

11. The assembly of claim 8, wherein the plurality of separate groups of land contacts consists of two groups of land contacts, and wherein the plurality of sockets consists of two sockets.

12. The assembly of claim 8, wherein the separate groups of land contacts include equal numbers of land contacts in each group.

13. The assembly of claim 8, wherein the separate groups of land contacts include different numbers of land contacts in each group.

14. The assembly of claim 8, wherein the plurality of sockets includes equal numbers of socket contacts in each socket.

15. The assembly of claim 8, wherein the plurality of sockets includes different numbers of socket contacts in each socket.

16. A method for coupling a land grid array package to a board, comprising:
providing a land grid array having a plurality of land contacts thereon, the plurality of land contacts including a first group of land contacts and a second group of land contacts;
providing first and second sockets coupled to the board, the first socket being a separate structure from the second socket;
bringing the first group of the land contacts into electrical contact with socket contacts in the first socket on the board; and
bringing the second group of the land contacts into electrical contact with socket contacts in the second socket on the board.

17. The method of claim 16, further comprising applying a force to enhance the contact between the land contacts of the first and second groups and the socket contacts of the first and second sockets.

18. The method of claim 16, wherein the plurality of land contacts include at least one additional group of land contacts in addition to the first group and the second group, and further comprising bringing the at least one additional group of land contacts into engagement with socket contacts of at least one additional socket, wherein the number of groups of land contacts equals the number of sockets.
